(19) United States
(12) Patent Application Publication
(10) Pub. No.: US 2014/0115367 A1
(43) Pub. Date: Apr. 24, 2014

(54) ELECTRONIC DEVICE OPERATING IN A PLURALITY OF POWER STATES, CONTROL METHOD THEREOF, AND STORAGE MEDIUM

(71) Applicant: CANON KABUSHIKI KAISHA, Tokyo (JP)

(72) Inventor: Yuji Soda, Kawasaki-shi (JP)

(73) Assignee: CANON KABUSHIKI KAISHA, Tokyo (JP)

(21) Appl. No.: 14/055,949

(22) Filed: Oct. 17, 2013

(30) Foreign Application Priority Data
Oct. 18, 2012 (JP) 2012-230946

(51) Int. Cl. G06F 1/32

(52) U.S. Cl. CPC G06F 1/3203
USPC 713/323

(57) ABSTRACT

An electronic device with improved usability when activated. The electronic device is capable of operating in a plurality of power states including a first power state, and a second power state in which the electric device is less in power consumption than in the first power state. The power state after activation of the electronic device is decided, based on status of connection of an external apparatus to the electronic device. The electronic device is shifted to the decided power state after the activation of the electronic device.

### BACKGROUND OF THE INVENTION

1. Field of the Invention

The present invention relates to an electronic device operating in a plurality of power states, a control method thereof, and a storage medium.

2. Description of the Related Art

In recent years, enhanced functions for controlling energy consumption are demanded in an electronic device including an image forming apparatus, from the viewpoint of preservation of global environment.

The image forming apparatus shifts to a standby state when the power switch is turned on after the plug-in, and the image forming apparatus waits in a print waiting state. In a recent image forming apparatus, the state of a controller shifts to a specific state after the plug-in, such as sleep, standby, and power switch input waiting, and the convenience of the user and energy saving are taken into account in the development of the product.

Particularly, the user's interest for a product with excellent energy saving and convenience is increasing recently, and companies make much effort in relation to these techniques.

An example of a power supply control method includes a control method for shifting to an energy saving state (see Japanese Laid-Open Patent Publication (Kokai) No. 2009-302831, for example). In the disclosed technique, control for shifting to one of a plurality of power saving states is performed according to the connection state of a plurality of connected peripheral devices.

However, in the technique disclosed in Japanese Laid-Open Patent Publication (Kokai) No. 2009-302831, only the control for shifting to one of the plurality of power saving states according to the connection state of the plurality of connected peripheral devices is performed.

Particularly, when a device is plugged in, the usability may not be excellent for the user in terms of convenience and energy saving, depending on the environmental conditions of the device and the state of the device after the startup.

For example, the standby state is the best for a user who wants to immediately use the device at hand, and from the viewpoint of energy saving, the sleep state is the best for a user who wants to use the device through a network. However, these are not taken into account in the technique, and the device may be started up in a state not desired by the user.

### SUMMARY OF THE INVENTION

An object of the present invention is to provide an electronic device with improved usability when activated, a control method thereof, and a storage medium.

In an aspect of the invention, there is provided an electronic device capable of operating in a plurality of power states including a first power state in which a user can immediately use the electronic device, and a second power state in which the electric device requires a predetermined time for shifting to the first power state and the electric device is less in power consumption less than in the first power state, the electronic device comprising: a decision unit configured to decide the power state after activation of the electronic device to be the first power state when an external apparatus is connected to the electronic device through a predetermined interface or when details of control for deciding the power state after the activation of the electric device to be the first power state are set; and a shifting unit configured to shift the electronic device to the power state decided by the decision unit after the activation of the electronic device.

According to the invention, it is possible to improve the usability of the electronic device when activated.

Further features of the present invention will become apparent from the following description of exemplary embodiments with reference to the attached drawings.

### BRIEF DESCRIPTION OF THE DRAWINGS

FIG. 1 is a view schematically showing a configuration of an image forming apparatus as an electronic device according to an embodiment of the present invention.

FIG. 2 is a view schematically showing a configuration of a control unit in the image forming apparatus of FIG. 1.

FIG. 3 is a view schematically showing a configuration of a power control unit in the image forming apparatus of FIG. 1.

FIG. 4 is a flowchart showing a procedure of a first power supply control process implemented by the image forming apparatus of FIG. 1.

FIG. 5 is a flowchart showing a procedure of a second power supply control process implemented by the image forming apparatus of FIG. 1.

FIG. 6 is a flowchart showing a procedure of a third power supply control process implemented by the image forming apparatus of FIG. 1.

### DESCRIPTION OF THE EMBODIMENTS

An embodiment of the present invention will now be described in detail with reference to the drawings.

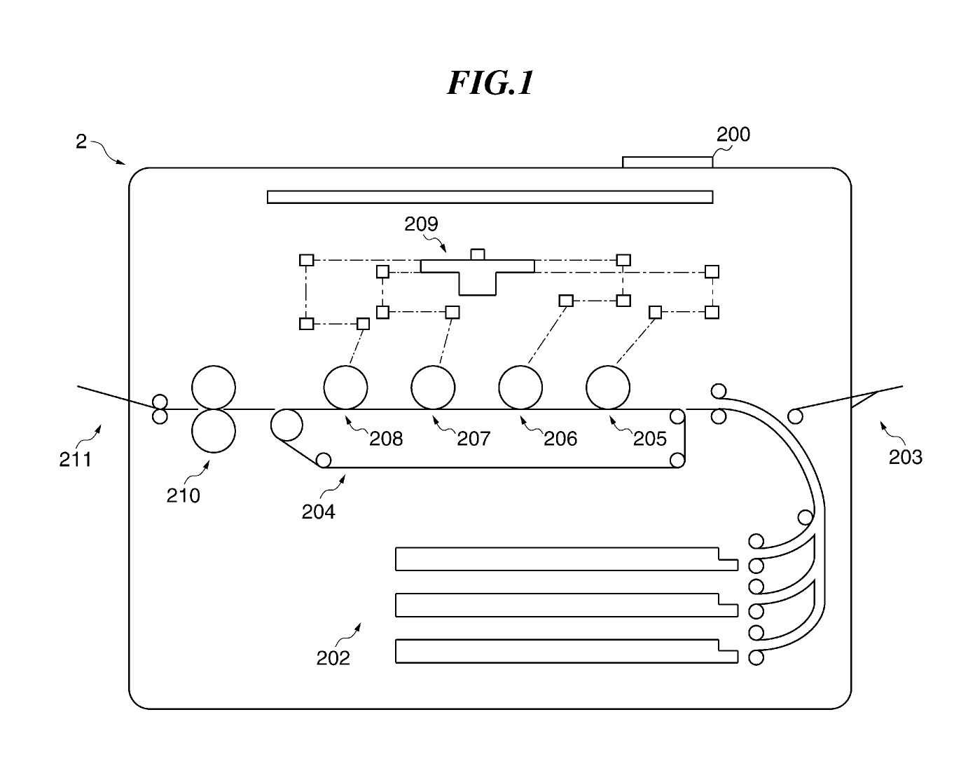

FIG. 1 is a view schematically showing a configuration of an image forming apparatus as an electronic device according to an embodiment of the present invention.

In FIG. 1, the electronic device according to the embodiment of the present invention includes an image forming apparatus 2. The image forming apparatus 2 receives print data such as character codes, form pattern data, compressed image data, and the like from an externally connected host computer. The image forming apparatus 2 creates character patterns, form patterns, and the like according to the received data or expands the compressed image data to print an image on a recording medium such as recording paper.

The image forming apparatus 2 includes an operation panel 200 provided with switches for various operations by the user, a display, and the like.

When printing is started, the image forming apparatus 2 starts an sheet feeding operation for feeding recording sheets from a sheet feed cassette 202 or a manual feed tray 203 to the apparatus. The fed recording sheet is transmitted to a conveyance unit 204 and is conveyed to sequentially pass through development units 205, 206, 207, and 208.

At the same time, an image conversion process is applied to image data of each color expanded by a controller described later, and the image data is transmitted to a laser scanner unit 209.

The laser scanner unit 209, which is a circuit for driving a semiconductor laser, turns on and off a laser beam emitted from the semiconductor laser according to the input image data. Photosensitive drums of the development units 205, 206, 207, and 208 perform laser scanning for every color based on the image data transmitted to the laser scanner unit 209, and desired color images are formed on the photosensitive drums corresponding to the colors.

The formation of the image data of each color is synchronized with the conveyance of the recording paper to transfer the color images of each color to the recording paper conveyed through the conveyance unit 204.

A fixation unit 210 thermally fixes the recording sheet provided with the color images, and the recording sheet is discharged to a sheet feed tray 211.

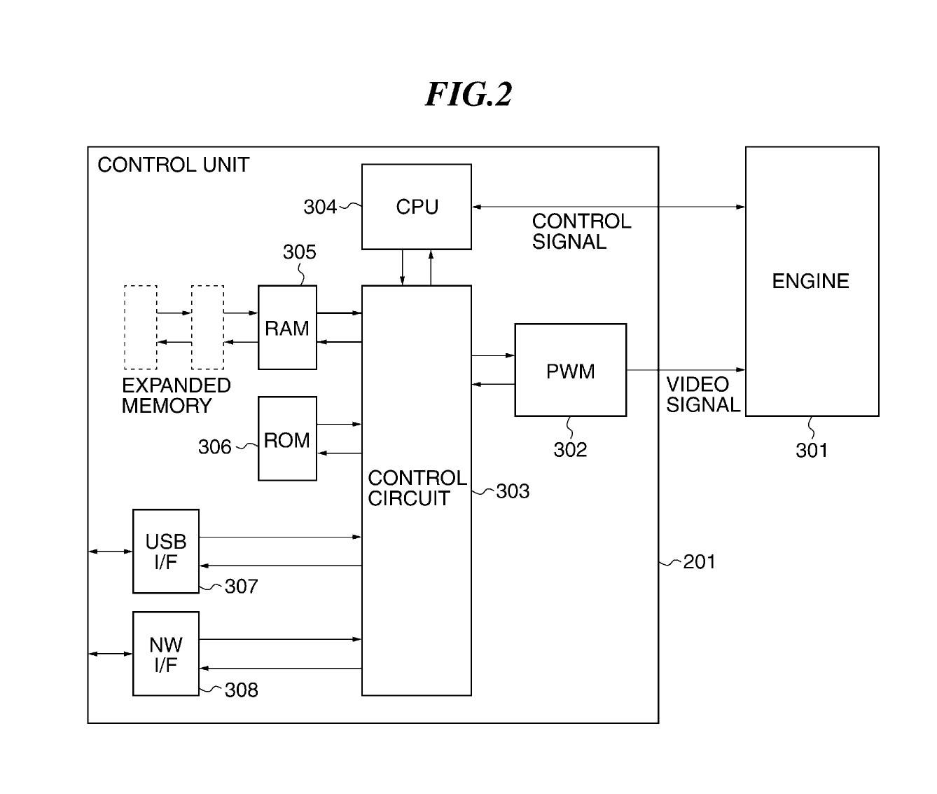

FIG. 2 is a view schematically showing a configuration of a control unit in the image forming apparatus of FIG. 1.

In FIG. 2, the control unit 201 includes a CPU 304, a control circuit 303, a PWM 302, a RAM 305, a ROM 306, a USB interface 307, and an NW interface 308.

The control circuit 303 is connected to the CPU 304, the PWM 302, the RAM 305, the ROM 306, the USB interface 307, and the NW interface 308 and transfers data to an engine 301.

The CPU 304 expands the program stored in the ROM 306 to the RAM 305 to control the entire image forming apparatus 2 according to the program.

In addition to programs, the RAM 305 stores data and the like received from the host computer. The ROM 306 is a non-volatile memory that stores programs and the like.

The USB interface 307 and the NW interface 308 are interfaces for connection to the host computer and other external apparatuses

The PWM 302 performs operation including correction of various image data and transfers the corrected video signal to the engine 301.

The control unit 201 of FIG. 2 analyzes data and the like received from the host computer and the like and mainly transfers character information to the laser scanner unit 209 of the engine 301 while converting the character information to a video signal of a corresponding character pattern or expanding compressed image data.

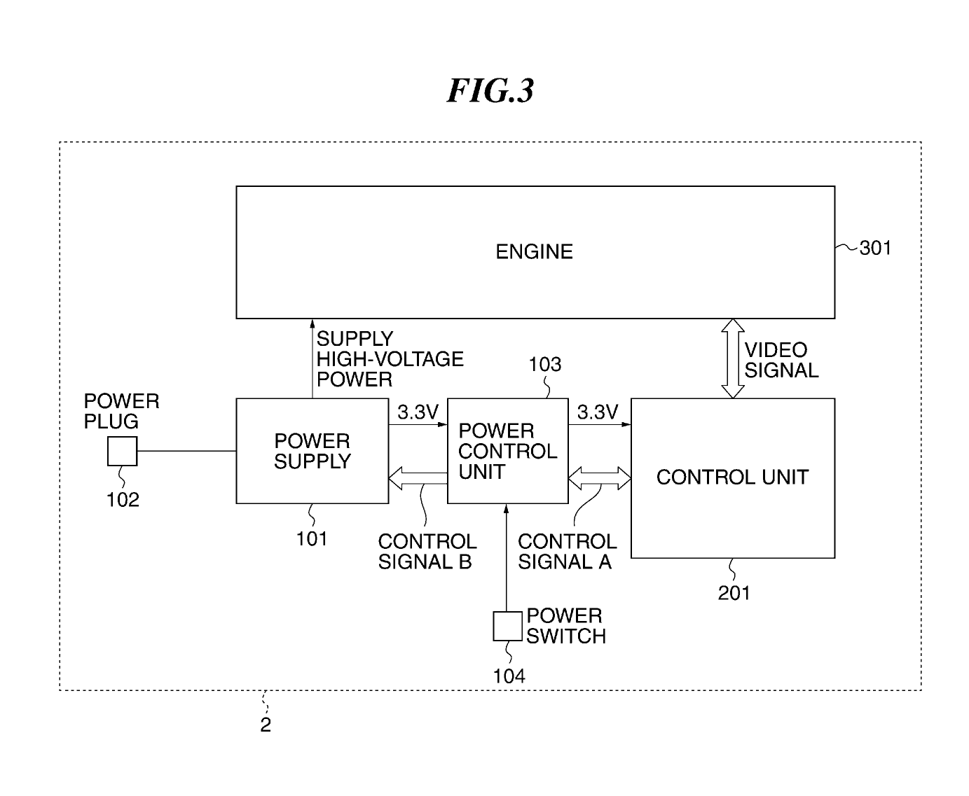

FIG. 3 is a view schematically showing a configuration of a power control unit in the image forming apparatus of FIG. 1.

In FIG. 3, power is supplied from an external power supply to a power plug 102 of an AC inlet terminal through an AC cable. A power supply 101 supplies DC power and supplies high-voltage power to the engine 301.

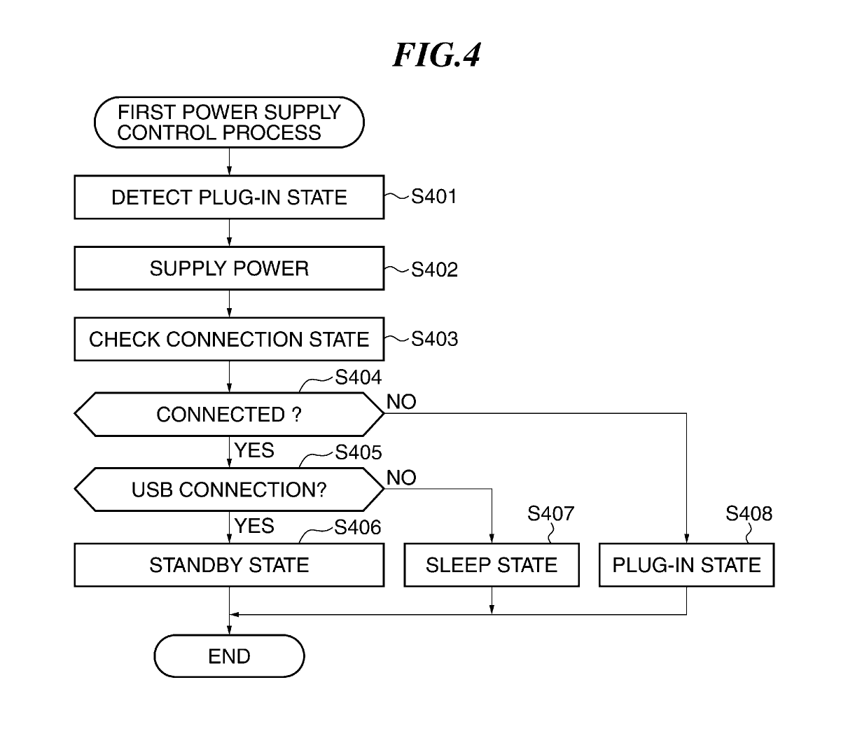

While 3.3 V is supplied from the power supply 101, the power control unit 103 controls whether to supply 3.3 V to the control unit 201. The power control unit 103 and the control unit 201 exchange a control signal A, and the power control unit 103 and the power supply 101 exchange a control signal B. The signals A and B are used in processes of FIGS. 4 to 6 described later.

It should be noted that although only 3.3 V is supplied to the control unit 201 in the present embodiment, other power, such as 5 V and 24 V, may also be supplied.

The power switch 104 is a switch pressed by the user, and the power control unit 103 monitors whether or not the power switch 104 is pressed.

Terms “plug-in state”, “sleep state”, and “standby state” will be described hereinafter.

The “plug-in state” denotes a state in which the power supply of 3.3 V from the power control unit 103 to the control unit 201 is terminated, and the press of the power switch 104 is monitored.

The supply of power to the control unit 201 is limited only to the necessary parts of the power supply 101 and the power control unit 103, and the power of 3.3 V is supplied again to the control unit 201 when the power switch 104 is pressed.

The “sleep state” denotes a state in which although the power of 3.3 V is supplied from the power control unit 103 to the control unit 201, minimum necessary power is supplied to the components of the control unit 201.

The “standby state” denotes a first power state in which the image forming apparatus 2 can be immediately used by a user, the power of 3.3 V is supplied to the control unit 201, and the power is also supplied to the engine 301.

Each of the “sleep state” and the “plug-in state” denotes a second power state in which the image forming apparatus 2 requires a predetermined time for shifting from the second power state to the first power state and the image forming apparatus 2 is less in power consumption than in the first power state. In this way, the image forming apparatus 2 can operate in a plurality of power states including the first power state and the second power state.

FIG. 4 is a flowchart showing a procedure of a first power supply control process implemented by the image forming apparatus of FIG. 1.

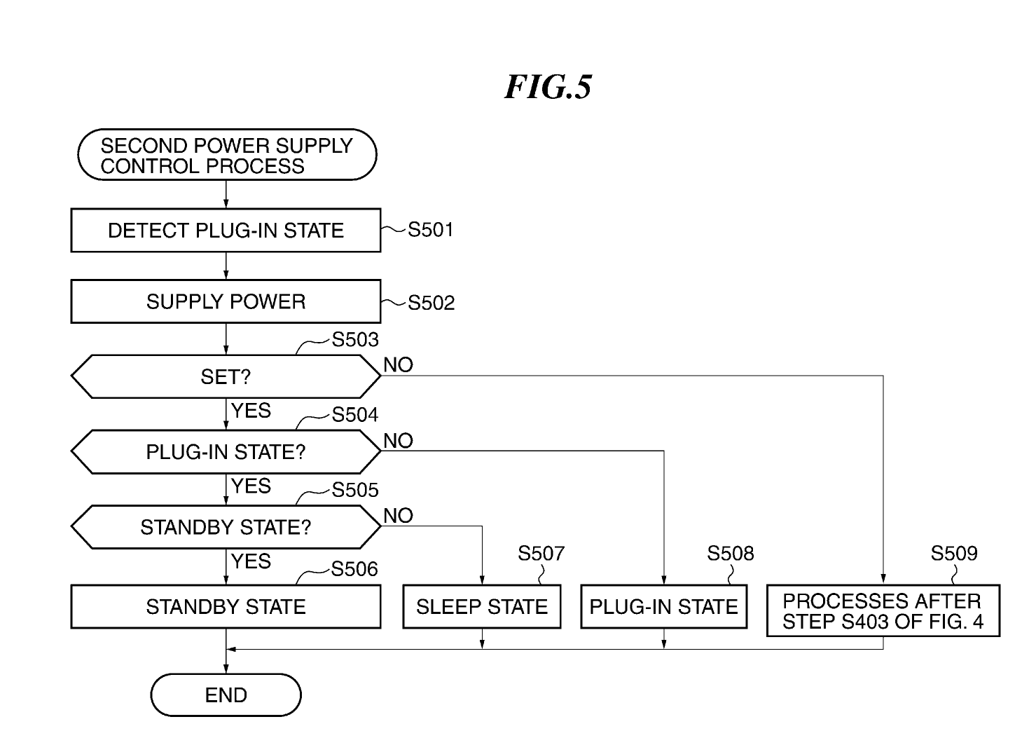

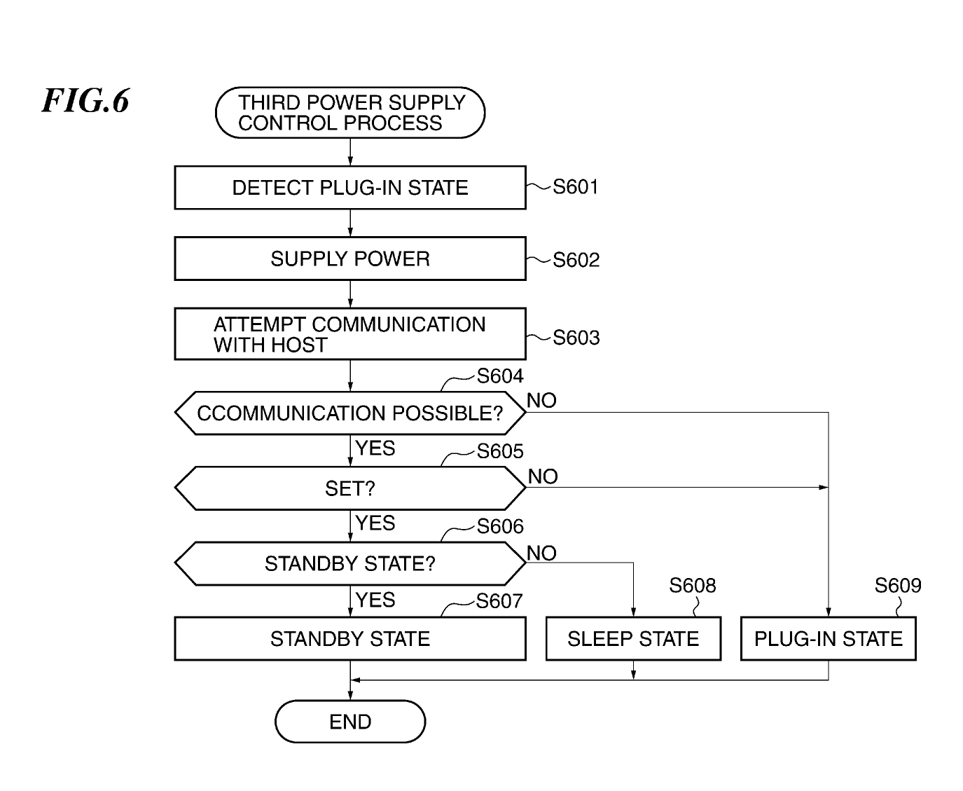

The process is implemented by the CPU 304 in FIG. 2. The same is true of the processes of FIGS. 5 and 6 described later.

In FIG. 4, when the “plug-in state” is detected by insertion of the power plug 102 from a state in which the power plug 102 is not inserted (step S401), power is supplied to the power supply 101, the power supply 101 supplies power of 3.3 V to the power control unit 103, and the power control unit 103 supplies power of 3.3 V to the control unit 201 (step S402). In this case, the power control unit 103 waits for the control signal A output from the control unit 201.

The control unit 201 supplied with 3.3 V supplies power only to necessary parts and checks whether or not a cable is connected to the USB interface 307 or the NW interface 308 (step S403).

As a result of the check, it is determined whether or not a cable is connected to the USB interface 307 or the NW interface 308 (step S404). If a cable is connected to the USB interface 307 or the NW interface 308 (YES to the step S404), it is determined whether or not the connection is to the USB interface 307 (step S405).

As a result of the determination of step S405, if the connection is to the USB interface 307 (YES to the step S405), the power state after the activation of the image forming apparatus 2 is decided to be the first power state (decision unit), and hence the power control unit 103 outputs the control signal B to the power supply 101 to supply each voltage to the engine 301, with the power control unit 103 shifting to the “standby state” (step S406) (shifting unit), followed by the process terminating.

On the other hand, as a result of the determination of the step S405, if the connection is not to the USB interface 307 (NO to the step S405), the power control unit 103 shifts to the “sleep state” (step S407), followed by the process terminating.

As a result of the determination of step S404, if a cable is not connected to the USB interface 307 or the NW interface 308 (NO to the step S404), the power control unit 103 shifts to the “plug-in state” (step S408), followed by the process terminating.

According to the process of FIG. 4, if the connection is through the USB interface 307 (YES to the step S405), it is judged that the user wants to immediately use the image forming apparatus 2, and the image forming apparatus 2 is activated in the “standby state” (step S406), and hence the user can immediately use the image forming apparatus 2, which improves the usability after the activation of the image forming apparatus 2.

FIG. 5 is a flowchart showing a procedure of a second power supply control process implemented by the image forming apparatus of FIG. 1.

Although the first power supply control process of FIG. 4 is performed according to the connected interface, a second power supply control process of FIG. 5 is performed in FIG. 4, control performed according to a setting value that is set in advance in the image forming apparatus 2 prior to the control according to the connected interface.

In FIG. 5, when the “plug-in state” is detected by insertion of the power plug 102 from a state in which the power plug 102 is not inserted (step S501), power is supplied to the power supply 101, the power supply 101 supplies power of 3.3 V to the power control unit 103, and the power control unit 103 supplies power of 3.3 V to the control unit 201 (step S502). In this case, the power control unit 103 waits for the control signal A output from the control unit 201.

The control unit 201 supplied with 3.3 V supplies power only to necessary parts and determines whether or not details of control are set by the user (step S503). If details of control are set by the user, the details of control are stored in the ROM 306; accordingly, whether the details of control are set by the user can be checked based on this.

As a result of the determination of step S503, if details of control are not set (NO to the step S503), the process after step S403 of FIG. 4 is implemented (step S509), followed by the process terminating.

On the other hand, as a result of the determination of the step S503, if details of control are set (YES to the step S503), it is determined whether or not the details of control are details of control for shifting to the plug-in state (step S504).

As a result of the determination of step S504, if the details of control are not details of control for shifting to the plug-in state (NO to the step S504), the power control unit 103 shifts to the “plug-in state” (step S508), followed by the process terminating.

On the other hand, as a result of the determination of step S504, if the details of control are details of control for shifting to the plug-in state (YES to the step S504), it is determined whether or not the details of control are details of control for shifting to the standby state (step S505).

As a result of the determination of step S505, if the details of control are not details of control for shifting to the standby state (NO to the step S505), the power control unit 103 shifts to the “sleep state” (step S507), followed by the process terminating.

On the other hand, as a result of the determination of step S505, if the details of control are details of control for shifting to the “standby state” (YES to the step S505), the power state after the activation of the image forming apparatus 2 is decided to be the first power state (decision unit), whereby the power control unit 103 shifts to the “standby state” (step S506) (shifting unit), followed by the process terminating.

In the process of FIG. 5, the details of control stored in advance in the ROM 306 are acquired, which causes the power state to be decided.

FIG. 6 is a flowchart showing a procedure of a third power supply control process implemented by the image forming apparatus of FIG. 1.

Although the second power supply control process of FIG. 5 is performed according to the details of control stored in the ROM 306, a third power supply control process of FIG. 6 is performed according to details of control stored in the connected host computer.

In FIG. 6, when the “plug-in state” is detected by insertion of the power plug 102 from a state in which the power plug 102 is not inserted (step S601), power is supplied to the power supply 101, the power supply 101 supplies power of 3.3 V to the power control unit 103, and the power control unit 103 supplies power of 3.3 V to the control unit 201 (step S602). In this case, the power control unit 103 waits for the control signal A output from the control unit 201.

The control unit 201 supplied with 3.3 V supplies power only to necessary parts and attempts to communicate with the host computer (step S603). The control unit 201 then determines whether or not the communication with the host computer is possible (step S604). The host computer can set details of control of the image forming apparatus 2 in advance.

As a result of the determination of step S604, if the communication with the host computer is not possible (NO in step S604), the power control unit 103 shifts to the “plug-in state” (step S609), followed by the process terminating.

On the other hand, as a result of the determination of step S604, if the communication with the host computer is possible (YES to the step S604), it is determined whether or not details of control are set to the host computer is determined (step S605).

As a result of the determination of step S605, if details of control are not set to the host computer (NO to the step S605), the power supply control unit 103 shifts to the “plug-in state” (step S609), followed by the process terminating.

On the other hand, as a result of the determination of step S605, if details of control are set to the host computer (YES to the step S605), it is determined whether or not the details of control are details of control for shifting to the “standby state” (step S606).

As a result of the determination of step S606, if the details of control are not details of control for shifting to the “standby state” (NO to the step S606), the power control unit 103 shifts to the “sleep state” (step S608), followed by the process terminating.

On the other hand, as a result of the determination of step S606, if the details of control are details of control for shifting to the “standby state” (YES to the step S606), the power state after the activation of the image forming apparatus 2 is decided to be the first power state (decision unit), whereby the power control unit 103 shifts to the “standby state” (step S607) (shifting unit), followed by the process terminating.

In the process of FIG. 6, the details of control are acquired by communicating with the host computer as a higher-level apparatus storing the details of control, which causes the power state to be decided.

In the processes of FIGS. 4 to 6 described above, the power state after the activation of the image forming apparatus 2 is decided to be the second power state in the embodiment if the conditions are not satisfied.

In this way, according to the processes of FIGS. 4 to 6, the power control unit 103 shifts to an optimal power supply state when the power is supplied, according to the environmental conditions of usage by the user and the connection state of the interface used, which improves the energy saving and the convenience of the user.

According to the processes of FIGS. 5 and 6, the power state after the activation can be set in advance, which improves the usability of the image forming apparatus 2 after the activation.

Aspects of the present invention can also be realized by a computer of a system or apparatus (or devices such as a CPU or MPU) that reads out and executes a program recorded on a non-transitory memory device to perform the functions of the above-described embodiment(s), and by a method, the steps of which are performed by a computer of a system or apparatus by, for example, reading out and executing a program recorded on a non-transitory memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims priority the benefit of Japanese Patent Application No. 2012-230946 filed Oct. 18, 2012, which is hereby incorporated by reference herein in its entirety.

What is claimed is:

1. An electronic device capable of operating in a plurality of power states including a first power state and a second power state in which the electric device is less in power consumption than in the first power state, the electronic device comprising:
a decision unit configured to decide the power state after activation of the electronic device, based on status of connection of an external apparatus to the electronic device; and
a shifting unit configured to shift the electronic device to the power state decided by said decision unit after the activation of the electronic device.

2. The electronic device according to claim 1, wherein said decision unit decides the power state after the activation of the electronic device to be the second power state when the external apparatus is not connected to the electronic device through the predetermined interface and when the details of control for deciding the power state after the activation of the electric device to be the first power state are not set.

3. The electronic device according to claim 1, wherein said decision unit decides the power state by acquiring the details of control stored in advance.

4. The electronic device according to claim 1, wherein said decision unit decides the power state by acquiring the details of control with communication with a higher-level apparatus storing the details of control.

5. The electronic device according to claim 1, wherein the predetermined interface comprises a USB interface.

6. A control method of an electronic device capable of operating in a plurality of power states including a first power state and a second power state the electric device is less in power consumption than in the first power state, the control method comprising:
a decision step of deciding the power state after activation of the electronic device, based on status of connection of an external apparatus to the electronic device; and
a shifting step of shifting the electronic device to the power state decided at said decision step after the activation of the electronic device.

7. The control method according to claim 6, wherein said decision step comprises deciding the power state after the activation of the electronic device to be the second power state when the external apparatus is not connected to the electronic device through the predetermined interface and when the details of control for determining the power state after the activation of the electric device to be the first power state are not set.

8. The control method according to claim 6, wherein said decision step comprising deciding the power state by acquiring the details of control stored in advance.

9. The control method according to claim 6, wherein said decision step comprising deciding the power state by acquiring the details of control with communication with a higher-level apparatus storing the details of control.

10. The control method according to claim 6, wherein the predetermined interface comprises a USB interface.

11. A storage medium storing a program for causing a computer to implement a control method of an electronic device capable of operating in a plurality of power states including a first power state in which a user can immediately use the electronic device, and a second power state in which the electric device requires a predetermined time for shifting to the first power state and the electric device is less in power consumption than in the first power state, the control method comprising:
a decision step of deciding the power state after activation of the electronic device, based on status of connection of an external apparatus to the electronic device; and
a shifting step of shifting the electronic device to the power state decided at said decision step after the activation of the electronic device.

12. An electronic device capable of operating in a plurality of power states including a first power state and a second power state in which the electric device is less in power consumption than in the first power state, the electronic device comprising:
a decision unit configured to decide the power state after activation of the electronic device, based on data for deciding the power state after the activation of the electric device; and
a shifting unit configured to shift the electronic device to the power state decided by said decision unit after the activation of the electronic device.
